(19) United States
(12) Patent Application Publication
(10) Pub. No.: US 2025/0157725 A1
(43) Pub. Date: May 15, 2025

(54) GENERAL-PURPOSE TRANSFORMER ASSEMBLY

(71) Applicant: TAI-TECH ADVANCED ELECTRONICS CO., LTD., Taoyuan City (TW)

(72) Inventors: Ming-Yen Hsieh, Taoyuan City (TW); Pao-Lin Shen, Taoyuan City (TW); Hsiang-Chung Yang, Taoyuan City (TW); Wei-Hsuan Lo, Taoyuan City (TW)

(21) Appl. No.: 18/510,558

(22) Filed: Nov. 15, 2023

(51) Int. Cl. H01F 27/30; H01F 27/24

(52) U.S. Cl. CPC H01F 27/306; H01F 27/24

(57) ABSTRACT

The general-purpose transformer assembly includes a base board, a number of transformer elements configured on a top side of the base board, at least two plate elements made of a magnetic metal, where the plate elements are directly stacked on top of at least two of the transformer elements, thereby covering these transformer elements altogether, and a connection element directly stacked on top of the plate elements, completely covering all plate elements and transformer elements. When there is a significant number of transformer elements, they can be freely arranged to more efficiently manage and utilize the space on the base board. The integration of multiple plate elements and transformer elements by the connection element facilitates the SMT (surface-mount technology) manufacturing process.

### BACKGROUND OF THE INVENTION

### (a) Technical Field of the Invention

The present invention is related to transformers, and more particularly to a general-purpose transformer assembly.

### (b) Description of the Prior Art

As shown in FIG. 1, a transformer assembly involves a number of transformers 20 configured on a base board 10, and a cover 30 is stacked on the transformers 20, thereby covering these transformers 20 and integrating them as a single unit.

This design has the benefit of reducing the distance between the transformers 20, thereby occupying less space on the base board 10. However, this integration of all transformers 20 by the cover 30 makes the arrangement of transformers 20 less flexible. The space on the base board 10, as such, cannot be efficiently utilized.

### SUMMARY OF THE INVENTION

To obviate the aforementioned shortcoming, the present invention provides a general-purpose transformer assembly, which includes
a base board;
a number of transformer elements configured on a top side of the base board;
at least two plate elements made of a magnetic metal, where each plate element is directly stacked on top of at least two of the transformer elements, thereby integrating these transformer elements together; and
a connection element directly stacked on top of the plate elements, completely covering all plate elements and transformer elements, thereby integrating the plate elements and the transformer elements together.

As described above, when there is a significant number of transformer elements, they can be freely arranged to more efficiently manage and utilize the space on the base board.

As described above, the present invention introduces freedom and flexibility into the arrangement of transformer elements, allowing for more efficient management and utilization to the space on the base board. The integration of multiple plate elements and transformer elements by the connection element facilitates the SMT (surface-mount technology) manufacturing process.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a conventional transformer assembly.

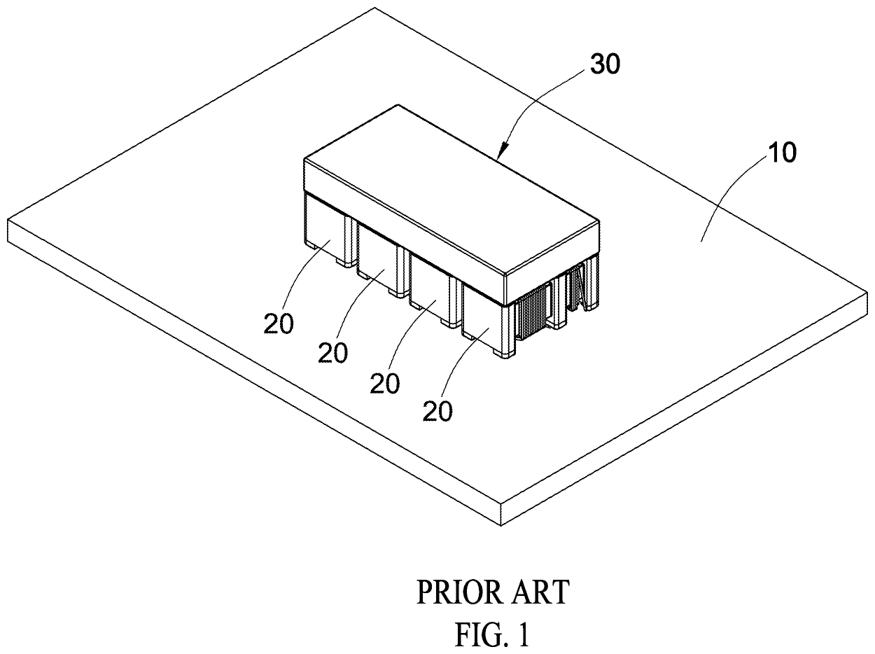

FIG. 2 is a perspective diagram showing a transformer assembly according to an embodiment of the present invention.

FIG. 3 is a perspective breakdown diagram showing the transformer assembly of FIG. 2.

FIG. 4 is a perspective diagram showing a transformer assembly according to another embodiment of the present invention where partition elements are included.

FIG. 5 is a perspective diagram showing a transformer assembly according to yet another embodiment of the present invention where partition elements and plate elements are integrally formed.

FIG. 6 is a perspective diagram showing a first arrangement scenario of the transformers of the transformer assembly of FIG. 2

FIG. 7 is a perspective diagram showing a second arrangement scenario of the transformers of the transformer assembly of FIG. 2

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

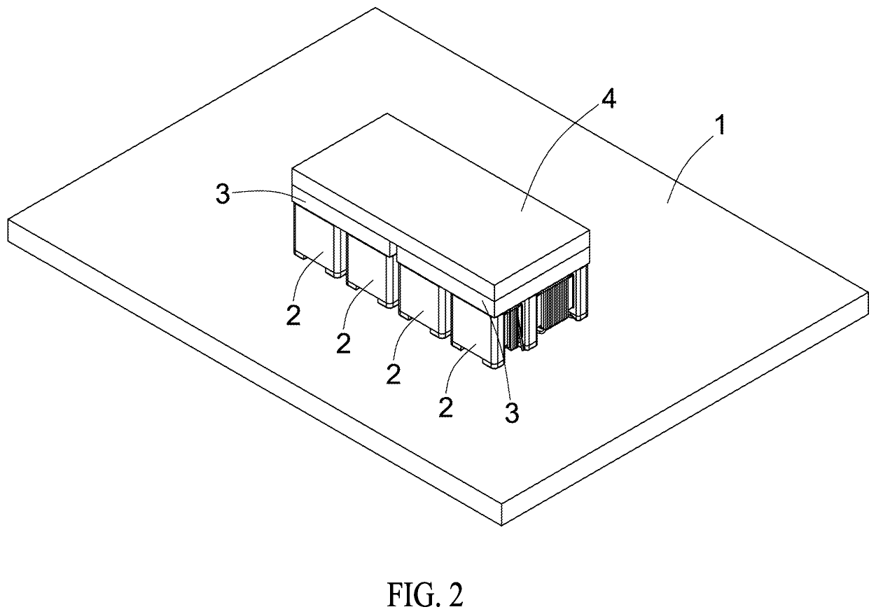

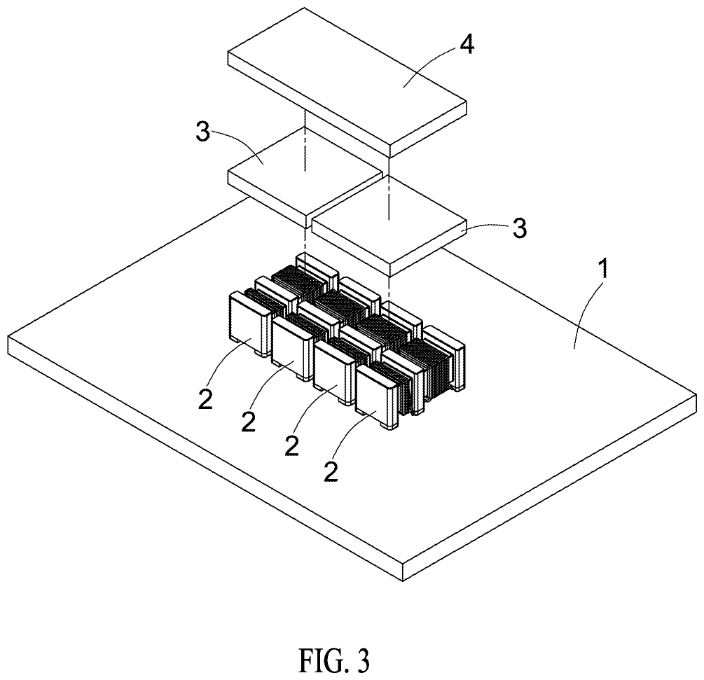

As shown in FIGS. 2 and 3, a general-purpose transformer assembly according to an embodiment of the present invention, includes
a base board 1;
a number of transformer elements 2 configured on a top side of the base board 1;
at least two plate elements 3 made of a magnetic metal, where each plate element 3 is directly stacked on top of at least two of the transformer elements 2, thereby integrating these transformer elements 2 together; and
a connection element 4 directly stacked on top of the plate elements 3, completely covering all plate elements 3 and transformer elements 2, thereby integrating the plate elements 3 and the transformer elements 2 together.

The connection element 4 can be made of a magnetic material, a ceramic material, ultra-violet (UV) resin, or an industrial plastic.

The magnetic material can be an iron power core.

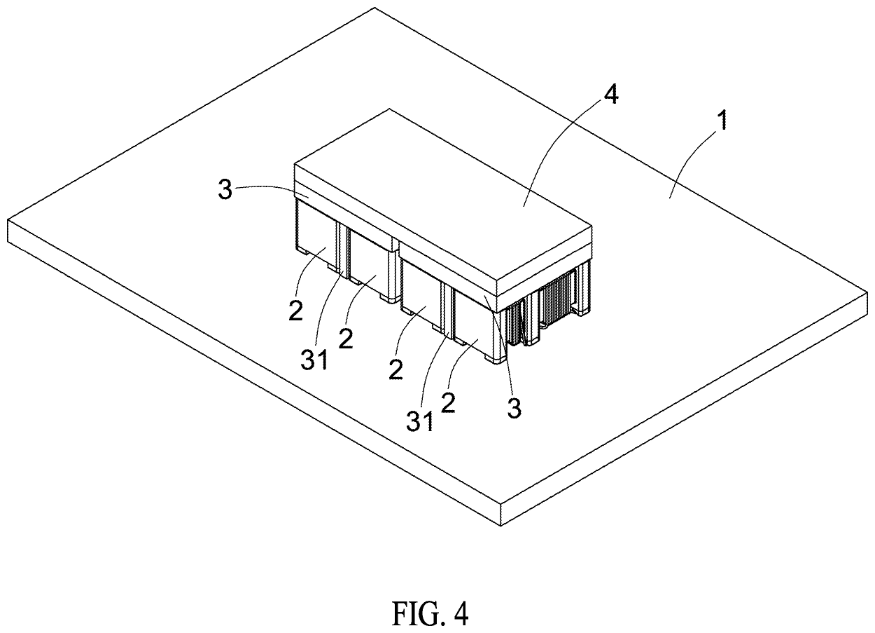

As shown in FIG. 4, each plate element 3 may include a partition element 31 separating the transformer elements 2 integrated by the plate element 3, preventing interference between these transformer elements 2 due to magnetic leakage.

The partition elements 31 can be made of a magnetic metal.

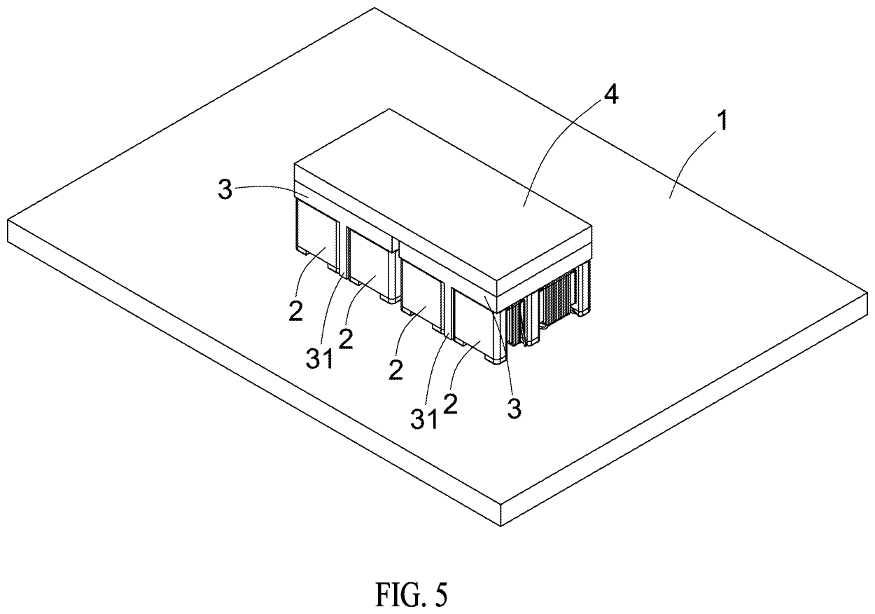

As shown in FIG. 5, each plate element 3 and its partition element 31 can be in integrally formed.

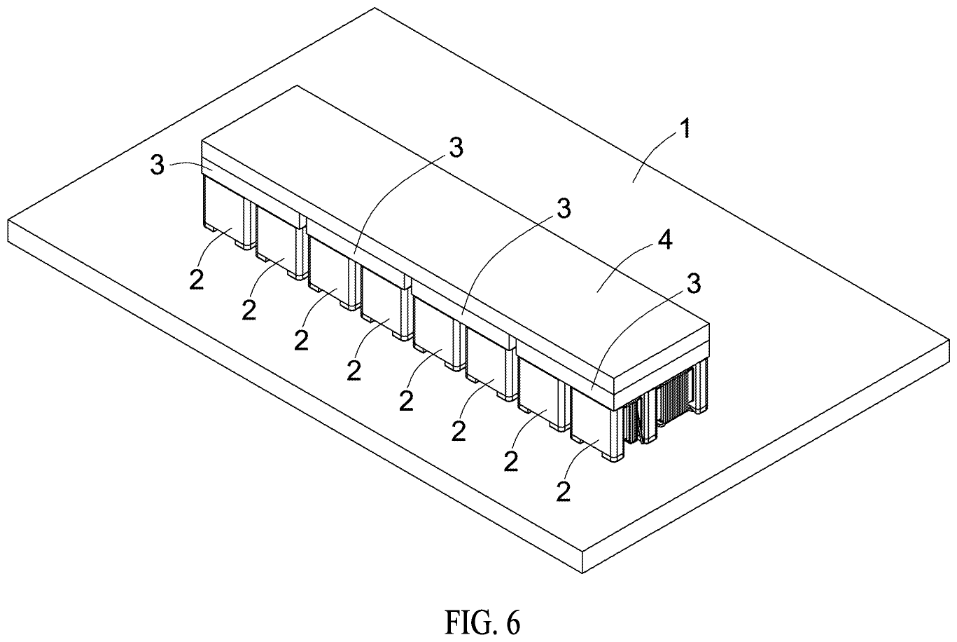

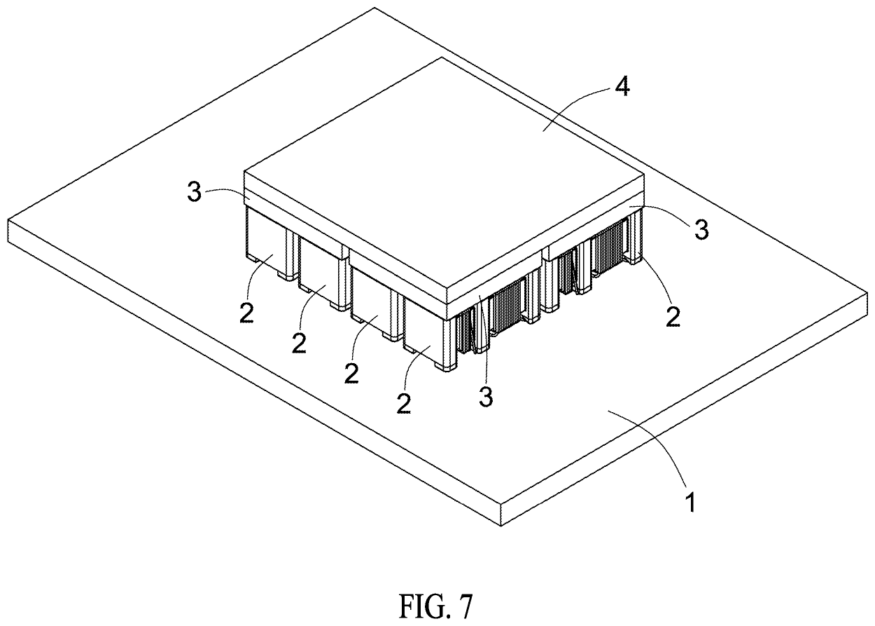

As shown in FIGS. 6 and 7, when there is a significant number of transformer elements 2, they can be freely arranged to more efficiently manage and utilize the space on the base board 1. Assuming that there are 8 transformer elements 2 and 4 plate elements 3, the 8 transformer elements 2 can be arranged into 4 groups, with two transformer elements 2 in each group covered by a plate element 3. The 4 groups of transformer elements 2 can be flexibly placed on the base board 1, as shown in FIG. 6, into a 1×4 array. Similarly, they can be placed into a 2×2 array as shown in FIG. 7.

As shown in FIG. 2, the connection element 4 further integrate the plate elements 3 and the transformer elements 2 into a single unit so that these plate elements 3 and transformer elements 2 can be more easily configured altogether in one processing step on the base board 1. Manufacturing process, such as SMT (Surface-mount technology), therefore, can be more conveniently conducted.

As described above, the present invention introduces freedom and flexibility into the arrangement of transformer elements 2, allowing for more efficient management and utilization to the space on the base board 1. The integration of multiple plate elements 3 and transformer elements 2 by the connection element 4 facilitates the SMT manufacturing process. The provision of the partition elements 31 prevents the magnetic leakage and interference between the transformer elements 2. The plate elements, on the other hand, reduce the distance between the transformer elements 2 so that they take up less space on the base board 1, an effect similarly achieved in the prior art.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A transformer assembly, comprising:
a base board;
a plurality of transformer elements configured on a top side of the base board;
at least two plate elements made of a magnetic metal, where each plate element is directly stacked on top of at least two of the transformer elements; and
a connection element directly stacked on top of the plate elements, completely covering all plate elements and transformer elements.

2. The transformer assembly according to claim 1, wherein each plate element comprises a partition element.

3. The transformer assembly according to claim 2, wherein each partition element is made of a magnetic metal.

4. The transformer assembly according to claim 2, wherein each plate element and its partition element are integrally formed.

5. The transformer assembly according to claim 1, wherein the connection element is made of a magnetic material, a ceramic material, ultra-violet (UV) resin, or an industrial plastic.

6. The transformer assembly according to claim 5, wherein the magnetic material is an iron power core.

7. The transformer assembly according to claim 1, wherein each plate element is made of a magnetic metal.
